(19) United States
(12) Patent Application Publication
(10) Pub. No.: US 2014/0074754 A1
(43) Pub. Date: Mar. 13, 2014

(54) Method of Identifying Relative Strength of Mutual Funds

(71) Applicant: The Prestige Organization, Inc., Wappingers Falls, NY (US)

(72) Inventor: Mark A. Grimaldi, Poughkeepsie, NY (US)

(73) Assignee: The Prestige Organization, Inc., Wappingers Falls, NY (US)

(21) Appl. No.: 14/068,508

(22) Filed: Oct. 31, 2013

(51) Int. Cl. G06Q 40/06

(52) U.S. Cl. CPC G06Q 40/06
USPC 705/36 R

(57) ABSTRACT

Methods are provided for identifying the relative strength of mutual funds for strengthening an investment portfolio. The methods employ a strategies to rank mutual funds obtained from a database including data regarding a plurality of mutual funds of a predetermined universe of mutual funds. The mutual fund database includes for each of the plurality of mutual funds, factors comprising percent return, ulcer index, standard deviation, and relative strength index. The mutual funds can be ranked by at least two of the factors. A composite rank can be calculated for each mutual fund, and a list of mutual funds, sorted by relative strength, can be compiled.

### FIELD

The present disclosure relates generally to investment strategies and more specifically to strategies for investing in mutual or other types of investment funds.

### BACKGROUND

Two current investment selection methods are fundamental analysis and technical analysis.

Fundamental analysis pertains to a method of evaluating a security that entails attempting to measure its intrinsic value by examining related economic, financial, and other qualitative and quantitative factors. Fundamental analysts attempt to study everything that can affect the security's value, including macroeconomic factors, such as the overall economy and industry conditions, and company-specific factors, such as financial condition and management.

This method of security analysis is considered to be the opposite of technical analysis.

Fundamental analysis is about using real data to evaluate a security's value. Although most analysts use fundamental analysis to value stocks, this method of valuation can be used for just about any type of security.

For example, an investor can perform fundamental analysis on a bond's value by looking at economic factors, such as interest rates and the overall state of the economy, and information about the bond issuer, such as potential changes in credit ratings. For assessing stocks, this method uses revenues, earnings, future growth, return on equity, profit margins, and other data to determine a company's underlying value and potential for future growth. In terms of stocks, fundamental analysis focuses on the financial statements of the company being evaluated.

The problem with fundamental analysis is that it forces the investor to assume the following types of risk. Is the data on which they are relying accurate? Wall Street is littered with companies that have produced incorrect financial filings. It is also company-specific, leaving the investor the problem of needing to run the analysis many times to create a diversified portfolio.

On the other hand, technical analysis is a method of evaluating securities by analyzing statistics generated by market activity, such as past prices and volume. Technical analysts do not attempt to measure a security's intrinsic value, but instead use charts and other tools to identify patterns that can suggest future activity. Technical analysts believe that the historical performance of stocks and markets are indications of future performance.

In a shopping mall, a fundamental analyst would go to each store, study the product that was being sold, and then decide whether to buy it or not. By contrast, a technical analyst would sit on a bench in the mall and watch people go into the stores. Disregarding the intrinsic value of the products in the store, the technical analyst's decision would be based on the patterns or activity of people going into each store.

The problem with technical analysis is that an investor will study the past performance of the entire stock market for clues as to its next move. This creates unseen risk for the investor because it does not take into account the current macroeconomic and geopolitical conditions. It also exposes the investor to 100% of the market risk.

Technical analysis has been compared to market timing; a method of being all in or out of the market at any given time.

In addition to fundamental analysis and technical analysis, growth investing and value investing are two other current investment selection methods.

Growth investing pertains to a strategy whereby an investor seeks out stocks with what they deem good growth potential. In most cases a growth stock is defined as a company whose earnings are expected to grow at an above-average rate compared to its industry or the overall market. Growth investors often call growth investing a capital growth strategy, since investors seek to maximize their capital gains, with income/dividends of little concern.

Although it is often said that growth investing and value investing are diametrically opposed, a better way to view these two strategies is to consider a quote by well-known investor Warren Buffett: “growth and value investing are joined at the hip”. Another very famous investor, Peter Lynch, pioneered a hybrid of growth and value investing with what is now commonly referred to as a “growth at a reasonable price (GARP)” strategy.

The universal problem with “growth” investing is the risk to principle it creates. By seeking to maximize the growth of capital the investor is also exposing it to large amounts of risk.

Value investing relates to the strategy of selecting stocks that trade for less than their intrinsic values. Value investors actively seek stocks of companies that they believe the market has undervalued. They believe the market overreacts to good and bad news, resulting in stock price movements that do not correspond with the company's long-term fundamentals. The result is an opportunity for value investors to profit by buying when the price is deflated.

Typically, value investors select stocks with lower-than-average price-to-book or price-to-earnings ratios and/or high dividend yields.

The biggest problem for value investing is estimating intrinsic value. There is no “correct” intrinsic value. Two investors can be given the exact same information and place a different value on a company. For this reason, another central concept to value investing is that of “margin of safety”. This just means that the investor buys at a big enough discount to allow some room for error in the estimation of value.

In addition, the very definition of value investing is subjective. Some value investors only look at present assets and earnings and do not place any value on future growth. Other value investors base strategies completely around the estimation of future growth and cash flows. Despite the different methodologies, it all comes back to trying to buy something for less than it is worth.

Historically this approach is an attempt to isolate a single stock that is valued much below what its fundamentals would warrant. One large problem is that there are many stocks that trade at a discount to their intrinsic value for years at a time. Many more stocks never gain the attention of enough investors to bring their share price up to par. This can cause investment capital to lay dormant for years.

U.S. Pat. No. 8,346,649 and related U.S. Pat. No. 7,987,130 to Waldron et al. describe methods for generating a stock portfolio using determined growth and value scores.

U.S. Pat. No. 7,593,878 to Blitzer et al. discloses a method for selecting investment assets for a portfolio based on a score indicative of its style; growth or value.

U.S. Pat. No. 7,206,760 to Carey et al. describes a method of ranking securities based on three types of securities-related data: price appreciation, return-on-assets ratio, and price-to-cashflow ratio.

Published U.S. Patent Application 20060184438 to McDow describes a method of managing mutual funds and index exchange traded funds based on relative strengths and alphas of the index components.

Published U.S. Patent Application 20040083151 to Craig, et al shows a method for selecting a portfolio of securities for investment where each sector is ranked by market capitalization, return on assets, buyback yield, and bullish interest indicator.

### SUMMARY

Accordingly, it is an object of one or more embodiments of the present disclosure to identify current trends for the purpose of investment decisions. The present disclosure identifies current trends in real time. It allows one to identify which sectors of a financial market are gaining momentum, and just as importantly, losing momentum. The method is able to isolate specific sectors of the market such as banking, insurance, natural gas, natural resource, automobile, leisure, etc. The advantage is that by using method of the present disclosure, one can focus on just the sectors that show growth without investing in bad markets.

It is a further object of one or more embodiments of the present disclosure to provide information to investors to improve the performance of their investments.

It is a further object of one or more embodiments of the disclosure to provide a ranking of mutual funds, or other types of investment funds, such as exchange-traded funds (ETFs). When the term “mutual fund” is used in the present disclosure, it generally refers to open-ended mutual funds, or exchange-traded funds, though other types of investment funds may also be ranked using the methods disclosed.

Other objects will appear hereinafter.

The above and other objects of the present disclosure may be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising percent return, ulcer index, standard deviation, and relative strength index. The mutual funds are sorted by percent return and each fund is assigned a numerical rank according to percent return. Next, the mutual funds are sorted by one of ulcer index, standard deviation, or relative strength index. The funds are then assigned a numerical rank according to ulcer index, standard deviation, or relative strength index. A composite rank comprised of the numerical rank of percent return and numerical rank of one of ulcer index, standard deviation, or relative strength index is assigned to each fund. The mutual funds are then sorted by composite rank to identify relative strength of said mutual funds.

The above and other objects of the present disclosure may further be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising percent return, ulcer index, standard deviation, and relative strength index. The mutual funds are sorted by percent return and each fund is assigned a numerical rank according to percent return. The funds are then sorted one of three factor pairs, where factor pairs comprise ulcer index and standard deviation, ulcer index and relative strength index, or standard deviation and relative strength index. The funds are assigned two numerical ranks according to the factor pair used. The funds are assigned a composite rank comprised of the numerical rank of percent return and the two numerical ranks of the factor pair. The funds are sorted by composite rank.

The above and other objects of the present disclosure may also be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising ulcer index, standard deviation, and relative strength index. The mutual funds are sorted by ulcer index and assigned a numerical rank according to ulcer index. The funds are then sorted by either standard deviation or relative strength index and assigned a numerical rank by whichever factor is used. The funds are assigned a composite rank comprised of the numerical rank of ulcer index and the numerical rank of one of standard deviation or relative strength index. Finally, the mutual funds are sorted by composite rank.

The above and other objects of the present disclosure may further be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising ulcer index, standard deviation, and relative strength index. The mutual funds are sorted by ulcer index and assigned a numerical rank according to ulcer index. The funds are then sorted by and assigned a numerical rank according to standard deviation. Next, the funds are sorted by and assigned a numerical rank according to relative strength index. Each fund is assigned a composite rank comprised of the numerical rank of ulcer index, numerical rank of standard deviation and numerical rank of relative strength index. Finally, the mutual funds are sorted by composite rank.

In addition, the above and other objects of the present disclosure may further be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising standard deviation and relative strength index. The mutual funds are sorted by and assigned a numerical rank according to standard deviation. Next, the funds are sorted by and assigned a numerical rank according to relative strength index. A composite rank comprised of the numerical rank of standard deviation and the numerical rank of relative strength index is assigned to each fund. Finally, the mutual funds are sorted by composite rank.

Furthermore, the above and other objects of the present disclosure may further be accomplished by a method of generating a ranking of mutual funds in a computer system having memory. The method comprises electronically storing a mutual fund database in memory with the mutual fund database comprising data regarding a plurality of mutual funds of a predetermined universe of mutual funds. The mutual fund database comprises for each of the plurality of mutual funds, factors comprising percent return, ulcer index, standard deviation, and relative strength index. The mutual funds are sorted by and assigned a numerical rank according to percent return. Next the funds are sorted by and assigned a numerical rank according to ulcer index. Then the funds are sorted by and assigned a numerical rank according to standard deviation. Lastly, the funds are sorted by and assigned a numerical rank according to relative strength index. The mutual funds are assigned composite rank comprised of the numerical rank of percent return, numerical rank of ulcer index, numerical rank of standard deviation, said numerical rank of relative strength index. Finally, the mutual funds are sorted by composite rank.

### BRIEF DESCRIPTION OF THE DRAWINGS

The present disclosure will be more clearly understood from the following description taken in conjunction with the accompanying drawings in which like reference numerals designate similar or corresponding elements, regions and portions and in which:

FIG. 1 is a schematic flow chart depicting the steps of a mutual fund ranking process;

FIG. 2 is a schematic flow chart depicting a second embodiment of a mutual fund ranking process;

FIG. 3 is a schematic flow chart depicting a third embodiment of a mutual fund ranking process;

FIG. 4 is a schematic flow chart depicting a fourth embodiment of a mutual fund ranking process;

FIG. 5 is a schematic flow chart depicting a fifth embodiment of a mutual fund ranking process;

FIG. 6 is a schematic flow chart depicting a sixth embodiment of a mutual fund ranking process;

FIG. 7 is a block diagram of a computer system forming a part of disclosure;

FIG. 8 is a schematic flow chart depicting a further embodiment of a mutual fund ranking process.

### DESCRIPTION

The methods of the present disclosure help identify which sectors of a particular financial market are showing the greatest momentum. This information can then be used in the construction of an investment portfolio. The disclosure provides a ranking system that funnels individual mutual funds, for example as represented by sector specific mutual funds, through a series of filters. This process will assign each mutual fund a rank. The rank is based on, preferably, four key technical and fundamental criteria. Then the system sorts each sector by their ranking. This re-ranking process can be repeated preferably on a monthly basis, but can also be performed more or less frequently. This process solves many of the problems that exist with current methods of investment selection.

As a solution to the aforementioned problems with fundamental analysis, this system analyzes all funds giving the investor not only the single top sector but multiple top ranking sectors.

Technical analysis has been compared to market timing; a method of being all in or out of the market at any given time. This disclosure's method keeps the investor in a slice of the market at all times.

Contrary to growth investing, this disclosure's sector rotation system is not just “betting” on the next best thing. The risk to principle is systematically reduced by dividing the entire market into specific sectors and investing those sectors that rank the highest. This sector approach dramatically reduces the investors' risk to their capital.

As a solution to the aforementioned problems with value investing, this disclosure is not only able to identify which sectors are undervalued but also highlight the ones that are showing real signs of getting the recognition necessary to reach the point of being fully valued.

Four, preferably, types of current performance data, or as called hereinafter factors, used in the present disclosure are percent return, ulcer index, standard deviation, and relative strength index.

Percent return is determined by calculating the difference between the current price and some pre-determined time frame earlier price and then dividing the difference by the earlier price. Percent return timeframes used for the disclosed technique can include one-month, three-month, one-year, three-year or five-year time periods.

Ulcer index is a measure of volatility, and though other measures of volatility such as standard deviation measure both upward and downward movement, ulcer index only measures movement in the downward direction. Ulcer index is calculated over a number of days, d. Working from the oldest to the newest, the maximum price, max, is continuously recorded. Rᵢ=100*[(priceᵢ−max)/max]. The root mean square is then taken with these R values such that Ulcer Index=sqrt[(R₁²+R₂²+ . . . R_{d}²)/d], where sqrt means square root. Ulcer index is often calculated daily or weekly.

Standard deviation is another measure of volatility, a measure of variance from the mean. A low standard deviation indicates a more stable fund while a high standard deviation indicates a more volatile fund.

Relative strength index is an indicator of momentum. This index attempts to determine overvalued or undervalued securities. The calculation involves, within a given time period, the days of closing with a gain and days of closing with a loss. Thus Relative Strength Index=100−100/[1+(average of x days with gain/average of x days with loss)]. Relative Strength Index is on a scale from zero to one-hundred and a result near seventy indicates a security being overvalued and a result near thirty indicates a security being undervalued.

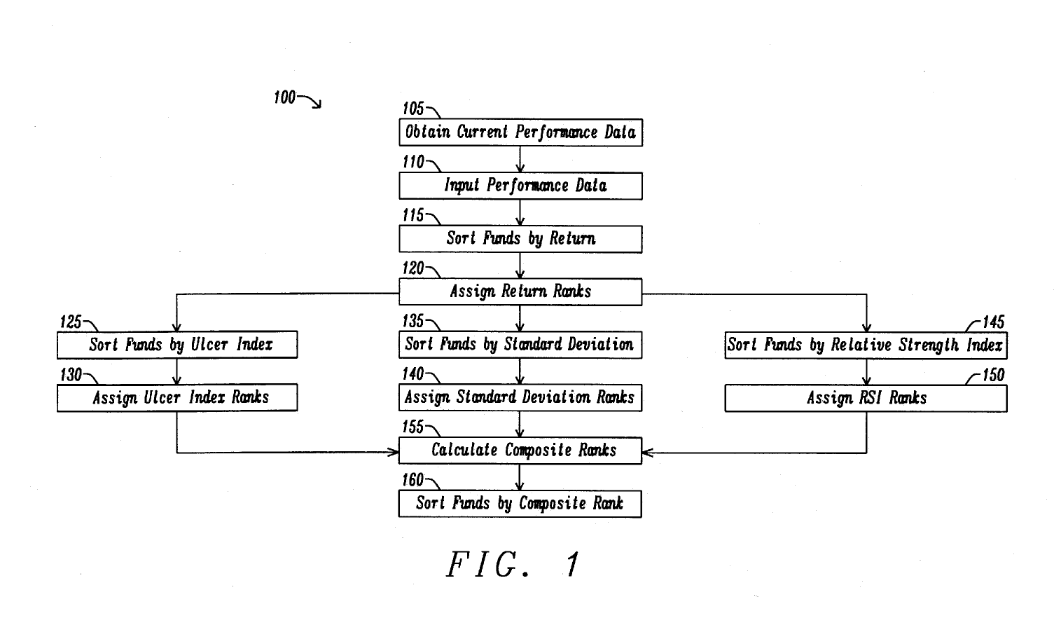

Referring to FIG. 1, in a first embodiment of a mutual fund ranking method 100, current performance data factors are obtained in step 105. Funds to be ranked preferably need to have been in existence for at least one year so that sufficient information is available about the fund's performance. Fund performance data is generally available and used for the previous 1-year, 3-year, 5-year and 10-year periods, depending on the age of the fund. In step 110, factors are entered into a computer system, for example, a spreadsheet program. In step 115, all of the mutual funds are sorted via the spreadsheet program according to percent return of each fund. In step 120, numerical percent return ranks are assigned to each mutual fund in order beginning with the greatest percent return. After assigning return ranks in step 120, funds may be further ranked according to one of three factors. In step 125, all of the mutual funds may be sorted according to ulcer index. In step 130, numerical ulcer index ranks may be assigned to each mutual fund in order beginning with the lowest ulcer index. Alternately, in step 135, all of the mutual funds may be sorted according to standard deviation. In step 140, numerical standard deviation ranks may be assigned to each mutual fund in order beginning with the lowest standard deviation. In a third alternative, in step 145, all of the mutual funds may be sorted according to relative strength index. In step 150, numerical relative strength index ranks may be assigned to each mutual fund in order beginning with the lowest relative strength index. In step 155, a composite rank is calculated for each mutual fund. The composite rank is calculated by summing the two factor ranks for each mutual fund. The fund with the lowest sum is assigned the first composite rank. The next lowest sum is assigned the second composite rank, et cetera. In step 160, all of the mutual funds are sorted according to composite rank.

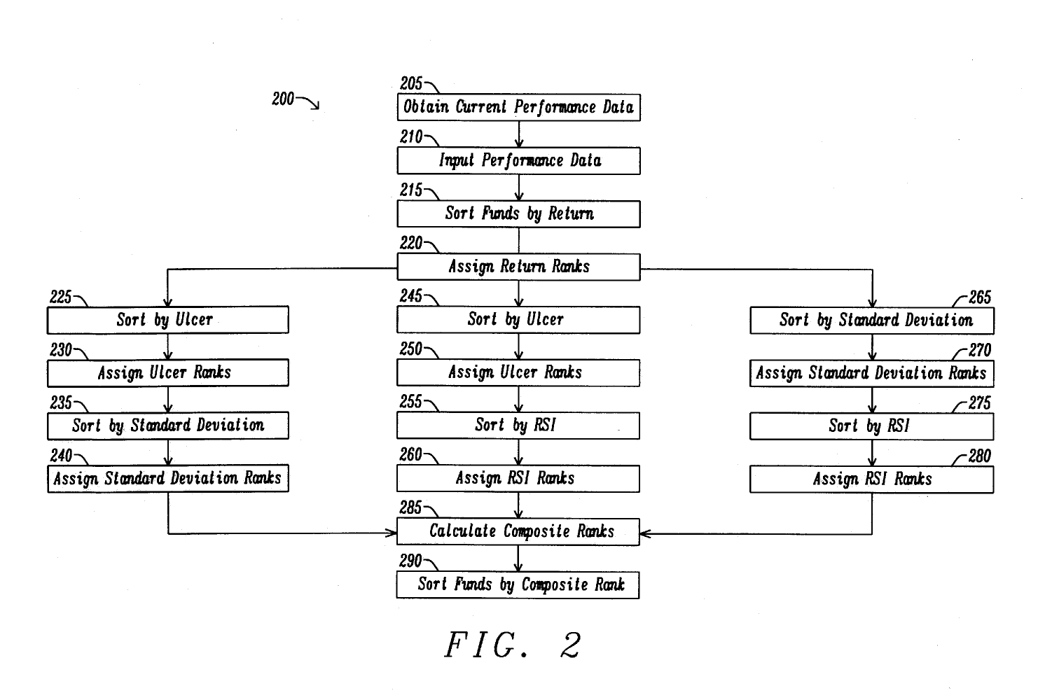

Referring to FIG. 2, in a second embodiment of a mutual fund ranking method 200, current performance data factors are obtained in step 205. In step 210, factors are entered into a computer system. In step 215, all of the mutual funds are sorted via the said spreadsheet program according to percent return of each fund. In step 220, numerical percent return ranks are assigned to each mutual fund in order beginning with the greatest percent return. After assigning percent return ranks in step 220, funds may be further ranked according to two of three factors. In step 225, all of the mutual funds may be sorted according to ulcer index. In step 230, numerical ulcer index ranks may be assigned to each mutual fund in order beginning with the lowest ulcer index. Then in step 235, all of the mutual funds may be sorted according to standard deviation. In step 240, numerical standard deviation ranks may be assigned to each mutual fund in order beginning with the lowest standard deviation. Alternately, in step 245, all of the mutual funds may be sorted according to ulcer index. In step 250, numerical ulcer index ranks may be assigned to each mutual fund in order beginning with the lowest ulcer index. Then in step 255, all of the mutual funds may be sorted according to relative strength index. In step 260, numerical relative strength index ranks may be assigned to each mutual fund in order beginning with the lowest relative strength index. In a third alternative, in step 265, all of the mutual funds may be sorted according to standard deviation. In step 270, numerical standard deviation ranks may be assigned to each mutual fund in order beginning with the lowest standard deviation. Then in step 275, all of the mutual funds may be sorted according to relative strength index. In step 280, numerical relative strength index ranks may be assigned to each mutual fund in order beginning with the lowest relative strength index. In step 285, a composite rank is calculated for each mutual fund. The composite rank is calculated by summing the three factor ranks for each mutual fund. The fund with the lowest sum is assigned the first composite rank. The next lowest sum is assigned the second composite rank, et cetera. In step 290, all of the mutual funds are sorted according to composite rank.

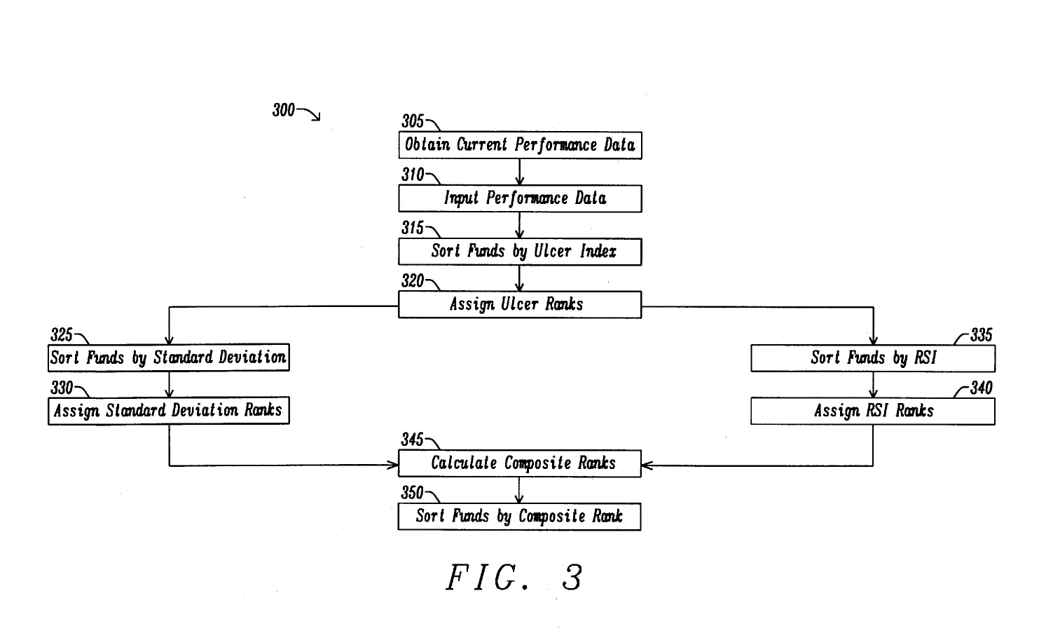

Referring to FIG. 3, in a third embodiment of a mutual fund ranking method 300, current performance data factors are obtained in step 305. In step 310, factors are entered into a computer system. In step 315, all of the mutual funds are sorted via the said spreadsheet program according to ulcer index of each fund. In step 320, numerical ulcer index ranks are assigned to each mutual fund in order beginning with the lowest ulcer index. After assigning ulcer index ranks in step 320, funds may be further ranked according to one of two factors. In step 325, all of the mutual funds may be sorted according to standard deviation. In step 330, numerical standard deviation ranks may be assigned to each mutual fund in order beginning with the lowest standard deviation. Alternately, in step 335, all of the mutual funds may be sorted according to relative strength index. In step 340, numerical relative strength index ranks may be assigned to each mutual fund in order beginning with the lowest relative strength index. In step 345, a composite rank is calculated for each mutual fund. The composite rank is calculated by summing the two factor ranks for each mutual fund. The fund with the lowest sum is assigned the first composite rank. The next lowest sum is assigned the second composite rank, et cetera. In step 350, all of the mutual funds are sorted according to composite rank.

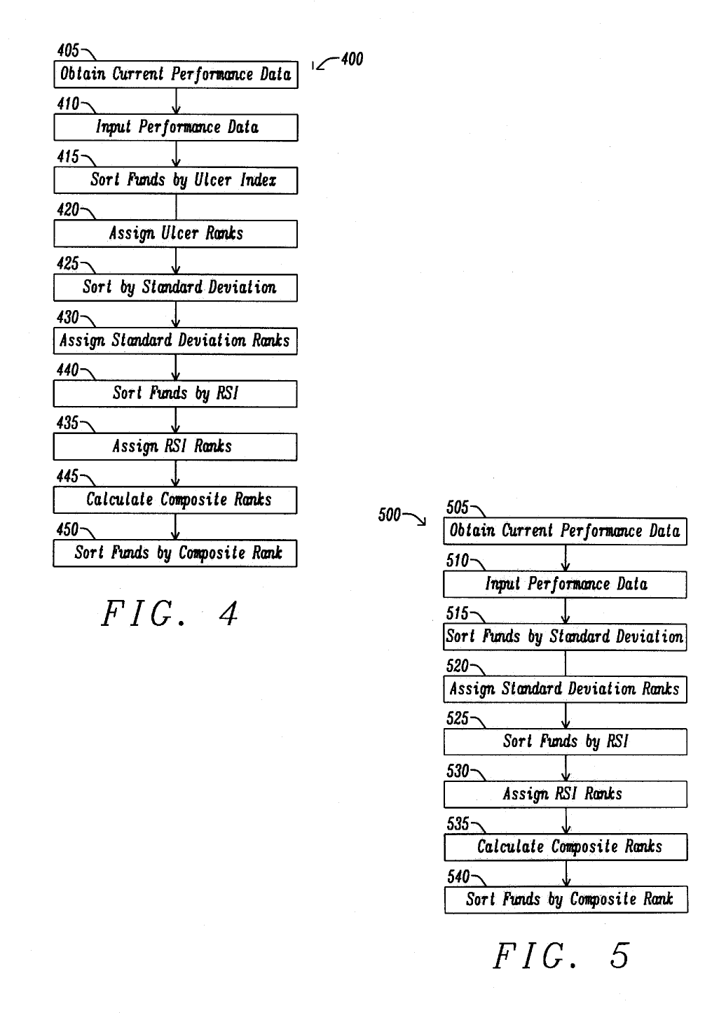

Referring to FIG. 4, in a fourth embodiment of a mutual fund ranking method 400, current performance data factors are obtained in step 405. In step 410, factors are entered into a computer system. In step 415, all of the mutual funds are sorted via the said spreadsheet program according to ulcer index of each fund. In step 420, numerical ulcer index ranks are assigned to each mutual fund in order beginning with the lowest ulcer index. In step 425, all of the mutual funds are sorted according to standard deviation. In step 430, numerical standard deviation ranks are assigned to each mutual fund in order beginning with the lowest standard deviation. In step 435, all of the mutual funds are sorted according to relative strength index. In step 440, numerical relative strength index ranks are assigned to each mutual fund in order beginning with the lowest relative strength index. In step 445, a composite rank is calculated for each mutual fund. The composite rank is calculated by summing the three factor ranks for each mutual fund. The fund with the lowest sum is assigned the first composite rank. The next lowest sum is assigned the second composite rank, et cetera. In step 450, all of the mutual funds are sorted according to composite rank.

Referring to FIG. 5, in a fifth embodiment of a mutual fund ranking method 500, current performance data factors are obtained in step 505. In step 510, factors are entered into a computer system. In step 515, all of the mutual funds are sorted via the said spreadsheet program according to standard deviation of each fund. In step 520, numerical standard deviation ranks are assigned to each mutual fund in order beginning with the lowest standard deviation. In step 525, all of the mutual funds are sorted according to relative strength index. In step 530, numerical relative strength index ranks are assigned to each mutual fund in order beginning with the lowest relative strength index. In step 535, a composite rank is calculated for each mutual fund. The composite rank is calculated by summing the two factor ranks for each mutual fund. The fund with the lowest sum is assigned the first composite rank. The next lowest sum is assigned the second composite rank, et cetera. In step 540, all of the mutual funds are sorted according to composite rank.

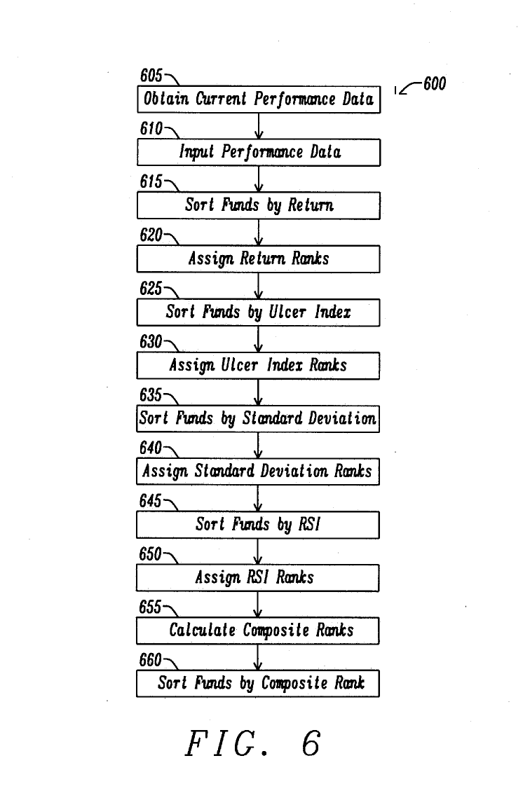

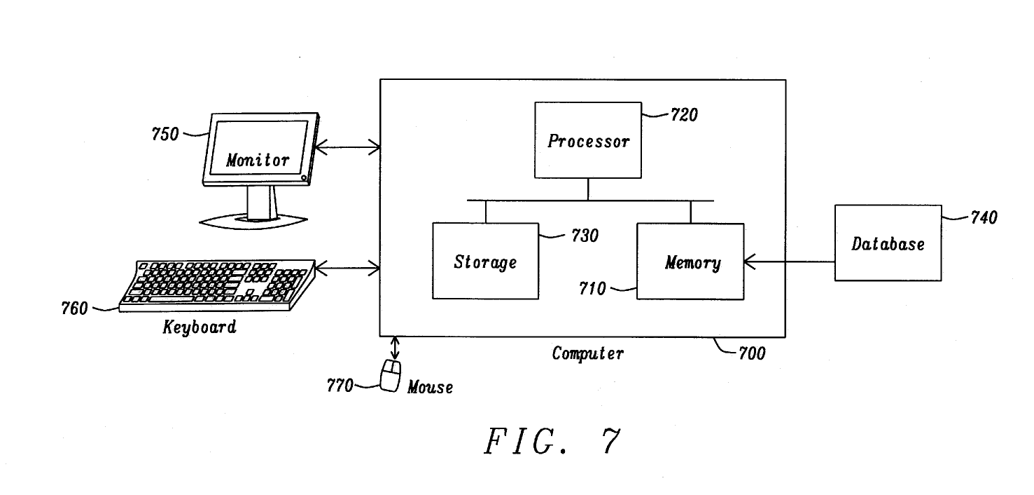

Referring to FIG. 6, in a sixth, and preferred, embodiment of a mutual fund ranking method 600, current performance data factors are obtained in step 605. In step 610, factors are entered into a computer system, for example, a spreadsheet program. In step 615, all of the mutual funds are sorted via the said spreadsheet program according to percent return of each fund. In step 620, numerical percent return ranks are assigned to each mutual fund in order beginning with the greatest percent return. In step 625, all of the mutual funds are sorted according to ulcer index. In step 630, numerical ulcer index ranks are assigned to each mutual fund in order beginning with the lowest ulcer index. In step 635, all of the mutual funds are sorted according to standard deviation. In step 640, numerical standard deviation ranks are assigned to each mutual fund in order beginning with the lowest standard deviation. In step 645, all of the mutual funds are sorted according to relative strength index. In step 650, numerical relative strength index ranks may be assigned to each mutual fund in order beginning with the lowest relative strength index. In step 655, a composite rank is calculated for each mutual fund. The composite rank is calculated by summing the four factor ranks for each mutual fund. The fund with the lowest sum is assigned the first composite rank. The next lowest sum is assigned the second composite rank, et cetera. In step 660, all of the mutual funds are sorted according to composite rank.

Referring to FIG. 7, current mutual fund performance data is obtained from database 740 and stored in memory 710 in computing system 700. Computing system 700 comprises at least a processor 720, storage 730, and memory 710. Data may be entered manually using a keyboard 760 and mouse 770 which are connected to a processor 720, downloaded from an Internet source (not shown), or transferred from a local storage device 730. The data input may include the names and symbols of mutual funds. In addition to the identity of the mutual funds, other data related to the funds are stored in memory 710. A spreadsheet or other program for making calculations according to the presently disclosed method is also loaded in memory 710. Such data for each fund may include percent return, ulcer index, standard deviation, and relative strength index.

In another embodiment additional factors are used, beyond those disclosed above of percent return, ulcer index, standard deviation, and relative strength index (hereinafter referred to as RUSR factors, for percent Return, Ulcer index, Standard deviation and Relative strength index). These additional factors include:
The 52-week high/low price, which provides an indication of where the mutual fund is in the business cycle, and whether the fund is breaking out from a recent trading range.
The yield or dividend the mutual fund is paying. The dividend is an important component of total return calculation.
Shame ratio, which helps determine whether high returns are due to good investment decisions or because of high risk.
Volume, which measures the strength of a market move. If the market moves up with a high volume of transactions, the move is more significant.

Ranking of investment funds using the above additional factors is done according to the following:
52-week high/low price: The higher the price of the fund relative to its 52-week range, the higher it is ranked.
Yield/dividend: The lower the yield the higher the fund is ranked. Often a dropping yield is the result of a rising price. As is well known, the yield of a stock or fund is its dividend per share divided by the price per share.
Sharpe Ratio: The higher the fund's Sharpe ratio, the higher the fund is ranked. The greater a fund's Sharpe ratio, the better its risk-adjusted performance.
Volume: The higher the volume of a fund, the higher it is ranked. A large increase in volume of a fund, especially if it occurs at the same time as upward movement in the overall market, is a positive sign.

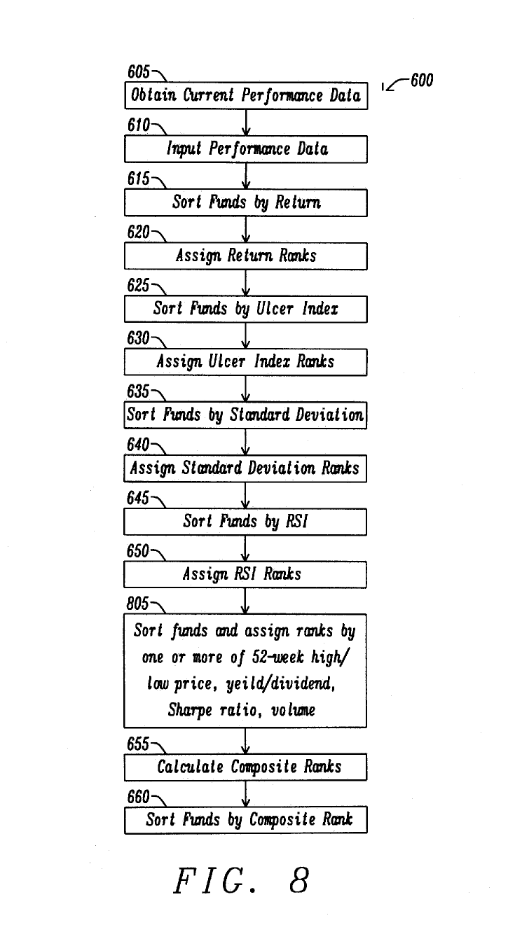

The four additional factors of 52-week high/low price, yield/dividend, Sharpe ratio, and volume (hereinafter 5YSV) may be used in addition to, or a substitute for, the earlier stated RUSR factors. For example, the embodiment illustrated in FIG. 6, which creates a composite ranking based on rankings of funds using the four RUSR factors, can be extended as shown in FIG. 8 to use some or all of the four 5YSV factors. Following steps 620-650, one, some or all of the 5YSV factors are used to sort the funds, and then assign a rank according to the factor(s), as shown in step 805. When all the sort/assign steps are completed—using the four RUSR factors plus one or more of the 5YSV factors—a composite rank 655 is calculated, and the funds sorted 660 by composite rank.

### Advantages

Accordingly, it is an object of one or more embodiments of the present disclosure to identify actual current trends for the purpose of investment decisions. The present disclosure identifies current trends in real time. It allows one to identify which sectors of a financial market are gaining momentum, and just as importantly, losing momentum. The method is able to isolate specific sectors of the market such as banking, insurance, natural gas, natural resource, automobile, leisure, etc. The advantage is that by using the methods of the present disclosure, one can focus on just the sectors that show growth without investing in bad markets.

The methods of the present disclosure help identify which sectors of a particular financial market are showing the greatest momentum. This information can then be used in the construction of an investment portfolio. The disclosure provides a ranking system that funnels individual mutual funds through a series of filters. This process will assign each mutual fund a rank. The rank is based on, preferably, four key technical and fundamental criteria. Then the system sorts each sector by their ranking. This re-ranking process can be repeated on a monthly basis. This process solves many of the problems that exist with current methods of investment selection.

The advantages of one or more embodiments of the present disclosure include identifying current trends for the purpose of investment decisions. The present disclosure identifies current trends in real time. It allows one to identify which sectors of a financial market are gaining momentum, and just as importantly, losing momentum. The method is able to isolate specific sectors of the market such as banking, insurance, natural gas, natural resource, automobile, leisure, etc. that show growth, without investing in poor markets.

While particular embodiments of the present disclosure have been illustrated and described, it is not intended to limit the disclosure, except as defined by the following claims.

What is claimed is:

1. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising percent return, ulcer index, standard deviation, and relative strength index;
sorting said mutual funds by said percent return;
assigning a numerical rank to each said fund according to said percent return;
sorting said mutual funds by one of said ulcer index, said standard deviation, or said relative strength index;
assigning a numerical rank to each said fund according to said ulcer index, said standard deviation, or said relative strength index;
assigning a composite rank comprised of said numerical rank of percent return and said numerical rank of one of said ulcer index, said standard deviation, or said relative strength index, and;
sorting the mutual funds by said composite rank to identify relative strength of said mutual funds.

2. The method of claim 1 wherein said composite rank is calculated by summing said numerical rank of percent return and said numerical rank of one of said ulcer index, said standard deviation, or said relative strength index.

3. The method of claim 1 wherein said ulcer index is calculated by a root mean square formula: sqrt[(R₁²+R₂²+ . . . R_{d}²)/d], where sqrt=square root, Rᵢ=100*[priceᵢ−max)/max], max=a maximum price of a security recorded during a process of a calculation, and d=total days in the calculation.

4. The method of claim 1 wherein said relative strength index is calculated by a formula: 100−100/[1+(average of x days with gain/average of x days with loss)] where x=total days in a calculation.

5. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising percent return, ulcer index, standard deviation, and relative strength index;
sorting said mutual funds by said percent return;
assigning a numerical rank to each said fund according to said percent return;
sorting said mutual funds by one of three factor pairs wherein factor pairs comprise said ulcer index and said standard deviation, said ulcer index and said relative strength index, or said standard deviation and said relative strength index;
assigning two numerical ranks to each said fund according to the said factor pair used;
assigning a composite rank comprised of said numerical rank of percent return and said two numerical ranks of said factor pairs, and;
sorting the mutual funds by said composite rank to identify relative strength of said mutual funds.

6. The method of claim 5 wherein said composite rank is calculated by summing said numerical rank of percent return and said numerical ranks of said factor pairs.

7. The method of claim 5 wherein said ulcer index is calculated by a root mean square formula: sqrt[(R₁²+R₂²+ . . . R_{d}²)/d], where sqrt=square root, Rᵢ=100*[priceᵢ−max)/max], max=a maximum price of a security recorded during a process of a calculation, and d=total days in the calculation.

8. The method of claim 5 wherein said relative strength index is calculated by a formula: 100−100/[1+(average of x days with gain/average of x days with loss)] where x=total days in a calculation.

9. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising ulcer index, standard deviation, and relative strength index;
sorting said mutual funds by said ulcer index;
assigning a numerical rank to each said fund according to said ulcer index;
sorting said mutual funds by one of said standard deviation and said relative strength index;
assigning a numerical rank to each said fund according to said standard deviation or said relative strength index;
assigning a composite rank comprised of said numerical rank of ulcer index and said numerical rank of one of said standard deviation or said relative strength index, and;
sorting the mutual funds by said composite rank to identify relative strength of said mutual funds.

10. The method of claim 9 wherein said composite rank is calculated by summing said numerical rank of ulcer index and said numerical ranks of one of said standard deviation or said relative strength index.

11. The method of claim 9 wherein said ulcer index is calculated by a root mean square formula: sqrt[(R₁²+R₂²+ . . . R_{d}²)/d], where sqrt=square root, Rᵢ=100*[priceᵢ−max)/max], max=a maximum price of a security recorded during a process of a calculation, and d=total days in the calculation.

12. The method of claim 9 wherein said relative strength index is calculated by a formula: 100−100/[1+(average of x days with gain/average of x days with loss)] where x=total days in a calculation.

13. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising ulcer index, standard deviation, and relative strength index;
sorting said mutual funds by said ulcer index;
assigning a numerical rank to each said fund according to said ulcer index;
sorting said mutual funds by said standard deviation;
assigning a numerical rank to each said fund according to said standard deviation;
sorting said mutual funds by said relative strength index;
assigning a numerical rank to each said fund according to said relative strength index;
assigning a composite rank comprised of said numerical rank of ulcer index, said numerical rank of standard deviation and said numerical rank of relative strength index, and;
sorting the mutual funds by said composite rank to identify relative strength of said mutual funds.

14. The method of claim 13 wherein said composite rank is calculated by summing said numerical rank of ulcer index, said numerical rank of standard deviation, and said numerical rank of relative strength index.

15. The method of claim 13 wherein said ulcer index is calculated by a root mean square formula: sqrt[(R₁²+R₂²+ . . . R_{d}²)/d], where sqrt=square root, Rᵢ=100*[priceᵢ−max)/max], max=a maximum price of a security recorded during a process of a calculation, and d=total days in the calculation.

16. The method of claim 13 wherein said relative strength index is calculated by a formula: 100−100/(average of x days with gain/average of x days with loss)] where x=total days in a calculation.

17. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising standard deviation and relative strength index;
sorting said mutual funds by said standard deviation;
assigning a numerical rank to each said fund according to said standard deviation;
sorting said mutual funds by said relative strength index;
assigning a numerical rank to each said fund according to said relative strength index;
assigning a composite rank comprised of said numerical rank of standard deviation and said numerical rank of relative strength index, and;
sorting the mutual funds by said composite rank to identify relative strength of said mutual funds.

18. The method of claim 17 wherein said composite rank is calculated by summing said numerical rank of standard deviation and said numerical rank of relative strength index.

19. The method of claim 17 wherein said relative strength index is calculated by a formula: 100−100/(average of x days with gain/average of x days with loss)] where x=total days in a calculation.

20. A method of generating a ranking of mutual funds in a computer system having memory, the method comprising:
electronically storing a mutual fund database in memory, the mutual fund database comprising data regarding a plurality of mutual funds of a predetermined universe of mutual funds, wherein the mutual fund database comprises for each of the plurality of mutual funds, factors comprising percent return, ulcer index, standard deviation, and relative strength index;
sorting said mutual funds by said percent return;
assigning a numerical rank to each said fund according to said percent return;
sorting said mutual funds by said ulcer index;
assigning a numerical rank to each said fund according to said ulcer index;
sorting said mutual funds by said standard deviation;
assigning a numerical rank to each said fund according to said standard deviation;
sorting said mutual funds by said relative strength index;
assigning a numerical rank to each said fund according to said relative strength index;
assigning a composite rank comprised of said numerical rank of percent return, said numerical rank of ulcer index, said numerical rank of standard deviation, and said numerical rank of relative strength index, and;
sorting the mutual funds by said composite rank to identify relative strength of said mutual funds.

21. The method of claim 20 wherein said composite rank is calculated by summing said numerical rank of ulcer index, said numerical rank of standard deviation, and said numerical rank of relative strength index.

22. The method of claim 20 wherein said ulcer index is calculated by a root mean square formula: sqrt[(R₁²+R₂²+ . . . R_{d}²)/d], where sqrt=square root, Rᵢ=100*[priceᵢ−max)/max], max=a maximum price of a security recorded during a process of a calculation, and d=total days in the calculation.

23. The method of claim 20 wherein said relative strength index is calculated by a formula: 100−100/(average of x days with gain/average of x days with loss)]
where x=total days in a calculation.
